(19) United States
(12) Patent Application Publication
(10) Pub. No.: US 2025/0124544 A1
(43) Pub. Date: Apr. 17, 2025

(54) UPSAMPLING LOW-RESOLUTION CONTENT WITHIN A HIGH-RESOLUTION IMAGE USING A GENERATIVE MODEL

(71) Applicant: ADOBE INC., SAN JOSE, CA (US)

(72) Inventors: Taesung Park, San Francisco, CA (US); Qing Liu, Santa Clara, CA (US); Zhe Lin, Clyde Hill, WA (US); Sohrab Amirghodsi, Seattle, WA (US); Elya Shechtman, Seattle, WA (US)

(21) Appl. No.: 18/487,764

(22) Filed: Oct. 16, 2023

(51) Int. Cl. G06T 3/40; G06T 5/50; G06T 11/00

(52) U.S. Cl. CPC G06T 3/4053; G06T 5/50; G06T 11/00; G06T 2207/20081; G06T 2207/20221

(57) ABSTRACT

Systems and methods for upsampling low-resolution content within a high-resolution image include obtaining a composite image and a mask. The composite image includes a high-resolution region and a low-resolution region. An upsampling network identifies the low-resolution region of the composite image based on the mask and generates an upsampled composite image based on the composite image and the mask. The upsampled composite image comprises higher frequency details in the low-resolution region than the composite image.

### BACKGROUND

The following relates generally to image processing, and more specifically to image upsampling. Image processing refers to the use of a computer to edit a digital image using an algorithm or a processing network. In some cases, image processing software can be used for various tasks, such as image editing, enhancement, restoration, image generation, etc. Some image generation systems implement machine learning techniques to generate a set of images based on a text prompt where the set of images vary in texture and detail.

Inpainting refers to the task of filling in regions of an image, whereas outpainting refers to adding content beyond the edge of an image. Generative models, like Generative Adversarial Networks (GANs), Variational Autoencoders (VAEs), and other machine learning (ML) based methods, have proven especially effective at these tasks. These models are trained on large amounts of data to learn parameter values that represent an implicit deep understanding of the underlying patterns and structures within images, such as the shapes of objects, textures, and colors. When prompted to inpaint a section of an image, such as a section defined by a user mask, these models generate content that is statistically similar to the training data in a way that provides a visually coherent and plausible completion.

### SUMMARY

Systems and methods for harmonizing low-resolution content within a high-resolution image are described. Embodiments include an image processing apparatus configured to generate low-resolution content based on a prompt and a mask using an image generation network, composite the low-resolution content into a higher resolution input image to form a composite image, and process the composite image using an upsampling network such that the low-resolution content is upsampled. The upsampling network is configured to upsample the composite image based on the composite image, the mask used in the initial generation, and a prompt embedding. In some embodiments, the upsampling network includes skip connections that include Fast Fourier Convolution (FFC) layers, which enable efficient transfer of detail from the higher resolution input image content during the upsampling process.

A method, apparatus, non-transitory computer readable medium, and system for image upsampling are described. One or more aspects of the method, apparatus, non-transitory computer readable medium, and system include obtaining a composite image and a mask, wherein the composite image includes a high-resolution region and a low-resolution region; identifying, by an upsampling network, the low-resolution region of the composite image based on the mask; and generating, using the upsampling network, an upsampled composite image based on the composite image and the mask, wherein the upsampled composite image comprises higher frequency details in the low-resolution region than the composite image.

A method, apparatus, non-transitory computer readable medium, and system for image upsampling are described. One or more aspects of the method, apparatus, non-transitory computer readable medium, and system include obtaining training data including a composite image including a low-resolution region from a low-resolution image and a high-resolution region from a high-resolution image, a mask indicating the low-resolution region, and a ground-truth composite image and training an upsampling network comprising parameters stored in the at least one memory, wherein the upsampling network is trained to generate an upsampled composite image based on a composite image and a mask, wherein the composite image includes a high-resolution region and a low-resolution region and the mask indicates the low-resolution region.

An apparatus, system, and method for image upsampling are described. One or more aspects of the apparatus, system, and method include at least one processor; at least one memory including instructions executable by the at least one processor; and an upsampling network comprising parameters stored in the at least one memory, wherein the upsampling network is trained to generate an upsampled composite image based on a low-resolution image, a high-resolution image, and a mask indicating a region of the high-resolution image.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of an upsampling pipeline according to aspects of the present disclosure.

FIG. 4 shows an example of a style-based generative adversarial network according to aspects of the present disclosure.

FIG. 5 shows an example of a diffusion architecture according to aspects of the present disclosure.

FIG. 6 shows an example of a diffusion process according to aspects of the present disclosure.

FIG. 7 shows an example of a method for harmonizing low-resolution image content within a high-resolution image according to aspects of the present disclosure.

FIG. 8 shows an example of a method for inpainting or outpainting generated content onto an image according to aspects of the present disclosure.

FIG. 9 shows an example of a method for image processing according to aspects of the present disclosure.

FIG. 10 shows an example of a pipeline for generating training images with masks according to aspects of the present disclosure.

FIG. 11 shows an example of a method for training a GAN-based upsampling network according to aspects of the present disclosure.

FIG. 12 shows an example of a method for image processing according to aspects of the present disclosure.

FIG. 13 shows an example of a computing device according to aspects of the present disclosure.

### DETAILED DESCRIPTION

Machine learning models can be used in several areas of image processing, including image generation. For example, in the task of inpainting, denoising diffusion probabilistic models (DDPMs) can be used to generate content in a specified region of an image. The inpainting process begins by initializing the selected region with random noise. Then, using the diffusion process, this noise is gradually transformed into plausible content. In some cases, the DDPM sample's image content adjacent to the region to condition its generation process and ensure cohesion. The DDPM's underlying structure allows it to model complex, high-level features of the training data, resulting in high-quality inpainting that maintains consistency with the surrounding image context.

In some cases, it is efficient to use the DDPM to produce low-resolution image content. However, when inpainting or outpainting a higher-resolution image, the lower-resolution image content may not plausibly match (e.g., “harmonize”) with the surrounding higher resolution content. Embodiments of the present disclosure include an upsampling network that is configured to process an image that includes the low-resolution generated image content adjacent to the higher-resolution content to produce a harmonized image at a same or greater resolution than the initial input image. Accordingly, embodiments improve the inpainting task by enabling efficient upsampling of composite images.

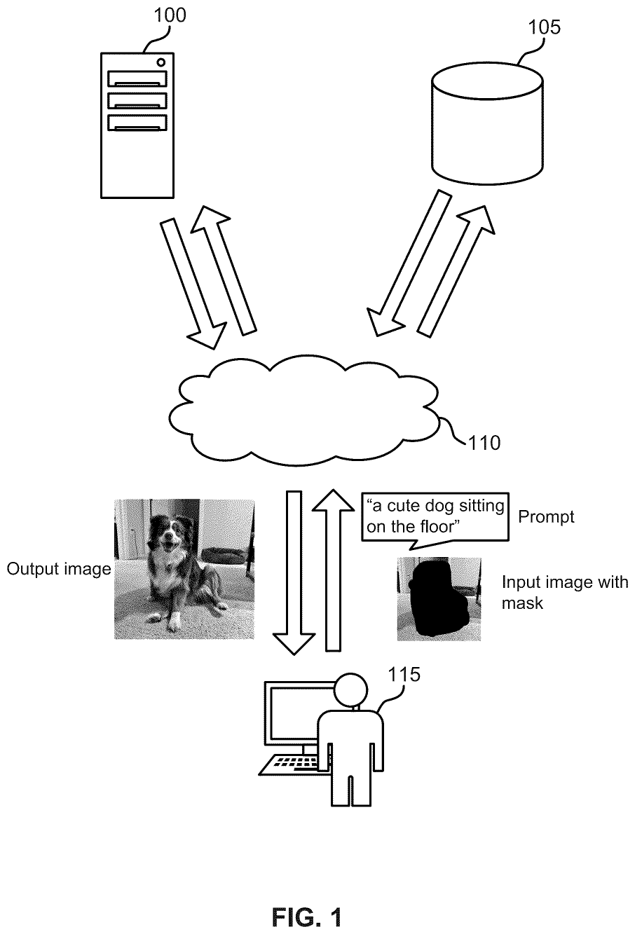

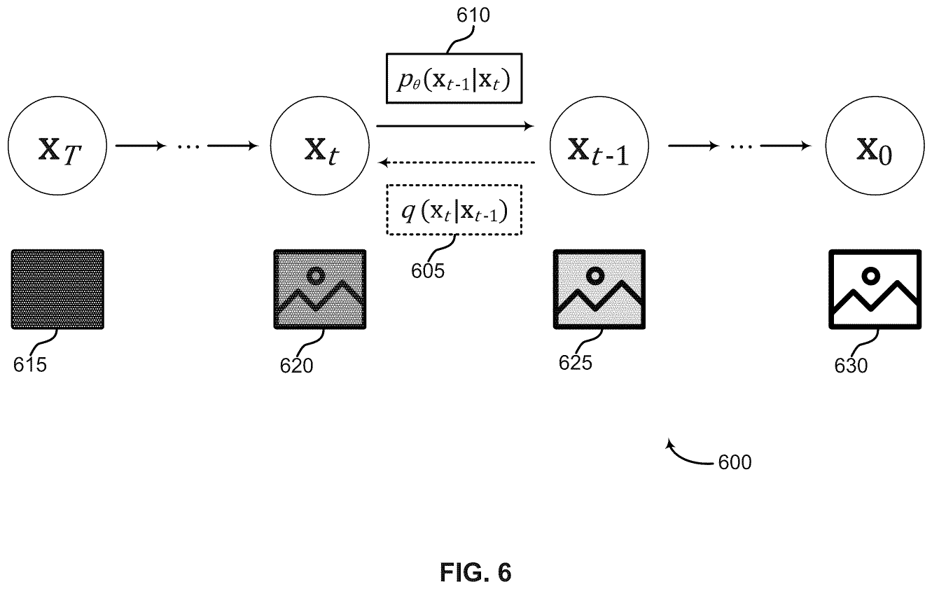

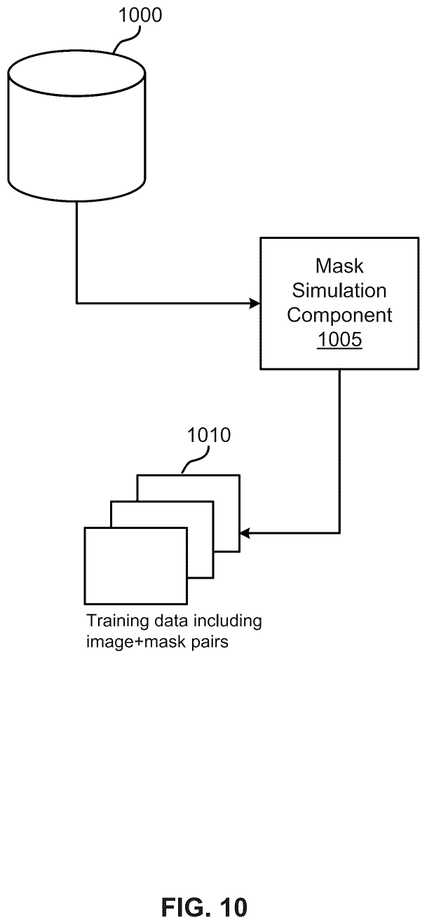

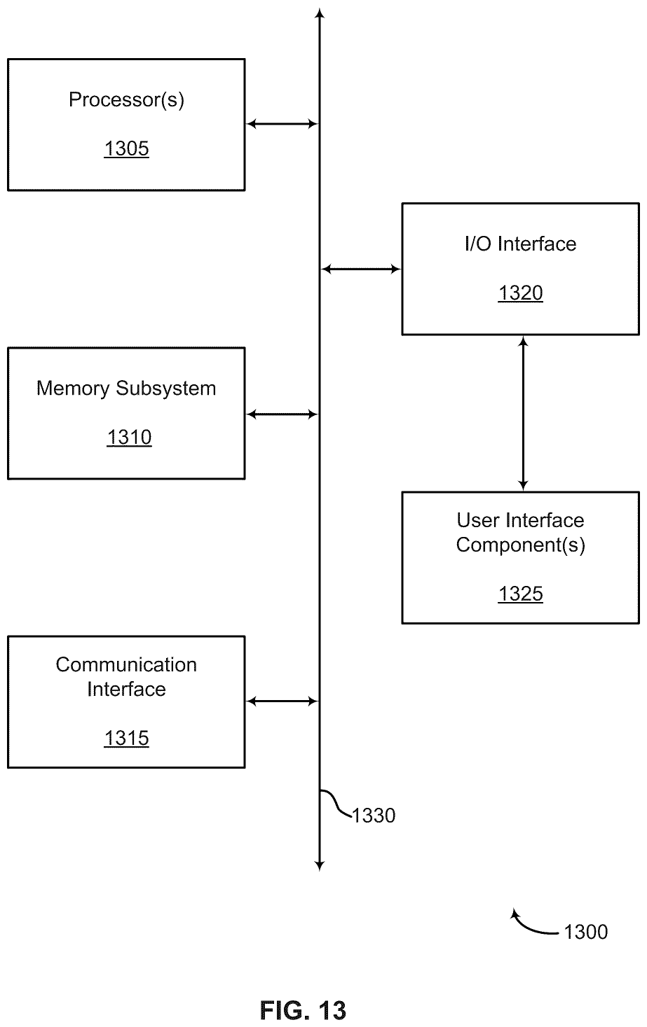

An image processing system configured to upsample low-resolution image content using a generative model is described with reference to FIGS. 1-5. Methods for generating upsampled images are described with reference to FIGS. 6-9. Methods for training the system are described with reference to FIGS. 10-12. A computing device configured to implement the image processing apparatus is described with reference to FIG. 13.

### Image Processing System

An apparatus for image upsampling is described. One or more aspects of the apparatus include at least one processor; at least one memory including instructions executable by the at least one processor; and an upsampling network comprising parameters stored in the at least one memory, wherein the upsampling network is trained to generate an upsampled composite image based on a low-resolution image, a high-resolution image, and a mask indicating a region of the high-resolution image.

In some aspects, the upsampling network comprises a generative adversarial network (GAN). In some aspects, the upsampling network includes a U-net architecture. For example, embodiments of the upsampling network include down-sampling layers and up-sampling layers. In some embodiments, an upsampling layer of the upsampling network comprises an attention layer. Some examples of the apparatus, system, and method further include a skip connection of the upsampling network comprising a Fast Fourier Convolution (FFC) layer.

Some examples of the apparatus, system, and method further include an image generation network configured to generate the low-resolution image. Some examples further include a text encoder configured to encode a text prompt to generate a text embedding, wherein the upsampling network generates the upsampled composite image based on the text embedding.

FIG. 1 shows an example of an image processing system according to aspects of the present disclosure. The example shown includes image processing apparatus 100, database 105, network 110, and user 115.

In one example, user 115 supplies an input image and mask that indicates a region of the image that user 115 wishes to replace with generated content, along with a generation prompt. The inputs may be sent to image processing apparatus 100 over network 110. Then, image processing apparatus 100 generates content within the region based on the mask and the prompt using an image generation network. In some cases, the image generation network generates content of a lower resolution (for example, a lower DPI) than the resolution of the original input image. The generated content is composited into the input image to create a composite input that includes both the low-resolution generated content and the high-resolution content from the input image. An upsampling network processes the composite input to increase the resolution of the generated content and harmonize the generated content with the rest of the image.

According to some aspects, one or more components of image processing apparatus 100 are implemented on a server. A server provides one or more functions to users linked by way of one or more of the various networks, such as network 110. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

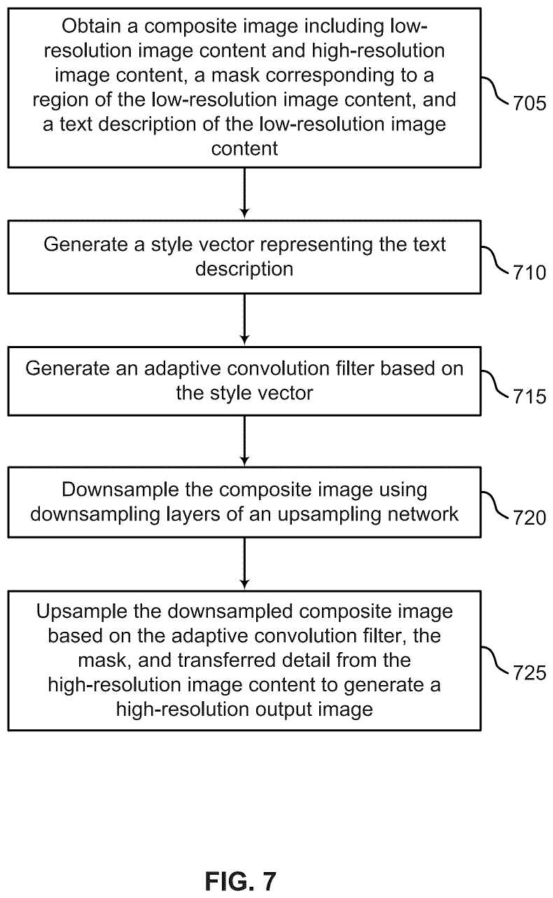

According to some aspects, image processing apparatus 100 obtains a low-resolution image, a high-resolution image, and a mask indicating a region of the high-resolution image. Image processing apparatus 100 may then upsample content from the low-resolution image to harmonize the content with content from the high-resolution. Details regarding methods used in the upsampling process will be described with reference to FIGS. 7-9.

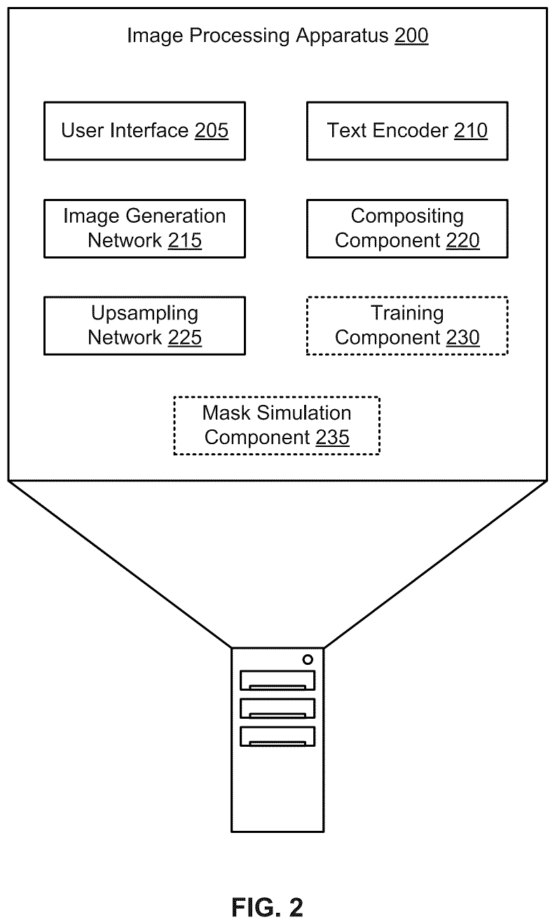

According to some aspects, image processing apparatus 100 obtains training data including a composite image including a low-resolution region from a low-resolution image and a high-resolution region from a high-resolution image, a mask indicating the low-resolution region, and a ground-truth composite image. In some examples, image processing apparatus 100 obtains a pretrained upsampling network, appends downsampling and Fast Fourier Convolution (FFC) layers to the pretrained upsampling network, and fine-tunes this network during a training phase. Image processing apparatus 100 is an example of, or includes aspects of, the corresponding element described with reference to FIG. 2.

Database 105 is configured to store information used by the image processing system, such as model parameters and training datasets. A database is an organized collection of data. For example, database stores data in a specified format known as a schema. A database may be structured as a single database, a distributed database, multiple distributed databases, or an emergency backup database. In some cases, a database controller may manage data storage and processing in database. In some cases, user 115 interacts with the database controller. In other cases, database controllers may operate automatically without user interaction.

Network 110 facilitates the transfer of information between image processing apparatus 100, database 105, and user 115. In some cases, a network is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of an image processing apparatus 200 according to aspects of the present disclosure. The example shown includes image processing apparatus 200, user interface 205, text encoder 210, image generation network 215, compositing component 220, upsampling network 225, training component 230, and mask simulation component 235.

Embodiments of image processing apparatus 200 include several components and sub-components. These components are variously named and are described so as to partition the functionality enabled by the processor(s) and the executable instructions included in the computing device used to implement image processing apparatus 200 (such as the computing device described with reference to FIG. 13). The partitions may be implemented physically, such as through the use of separate circuits or processors for each component or may be implemented logically via the architecture of the code executable by the processors.

Some components of image processing apparatus 200, such as text encoder 210, image generation network 215, and upsampling network 225, include models that are based on an artificial neural network (ANN). An ANN is a hardware or a software component that includes a number of connected nodes (i.e., artificial neurons), which loosely correspond to the neurons in a human brain. Each connection, or edge, transmits a signal from one node to another (like the physical synapses in a brain). When a node receives a signal, it processes the signal and then transmits the processed signal to other connected nodes. In some cases, the signals between nodes comprise real numbers, and the output of each node is computed by a function of the sum of its inputs. In some examples, nodes may determine their output using other mathematical algorithms (e.g., selecting the max from the inputs as the output) or any other suitable algorithm for activating the node. Each node and edge is associated with one or more node weights that determine how the signal is processed and transmitted.

During the training process, these weights are adjusted to improve the accuracy of the result (i.e., by minimizing a loss function which corresponds in some way to the difference between the current result and the target result). The weight of an edge increases or decreases the strength of the signal transmitted between nodes. In some cases, nodes have a threshold below which a signal is not transmitted at all. In some examples, the nodes are aggregated into layers. Different layers perform different transformations on their inputs. The initial layer is known as the input layer and the last layer is known as the output layer. In some cases, signals traverse certain layers multiple times.

In some examples, a user interface 205 is configured to receive inputs from a user and display outputs to the user. The user interface 205 may include hardware components such as an electronic display, as well as software components such as graphical user interface (GUI) elements. For example, user interface 205 may be implemented within image editing software that is executed by image processing apparatus 200, and may be configured to receive inputs such as text prompts and selections of items or regions on a display. In some examples, user interface 205 displays images to a user that are output from upsampling network 225.

Text encoder 210 is configured to process a text input and generate a text embedding therefrom. Embodiments of text encoder 210 include tokenizers or token-free models, autoencoders, or combinations thereof. In some cases, text encoder 210 produces an embedding of a constant size that is not dependent on the size of the input text. Embodiments of text encoder 210 include transformer components.

A transformer or transformer network is a type of neural network models used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights ‘a’.

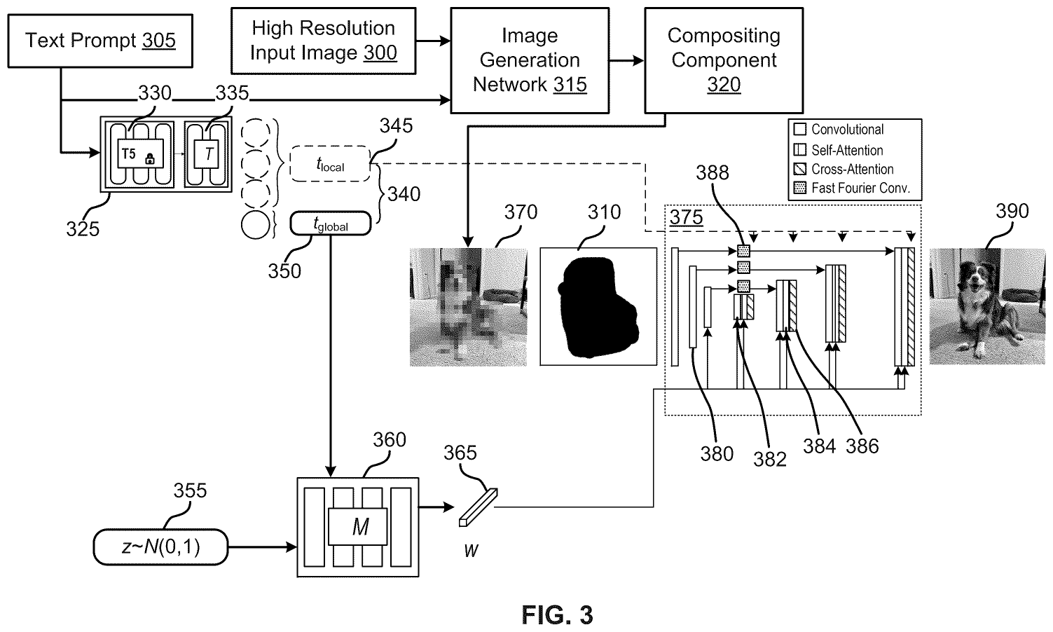

According to some aspects, text encoder 210 encodes a text prompt to obtain a text embedding, where the upsampled composite image is generated by upsampling network 225 based on the text embedding. Text encoder 210 is an example of, or includes aspects of, the corresponding element described with reference to FIGS. 3, 5, and 11.

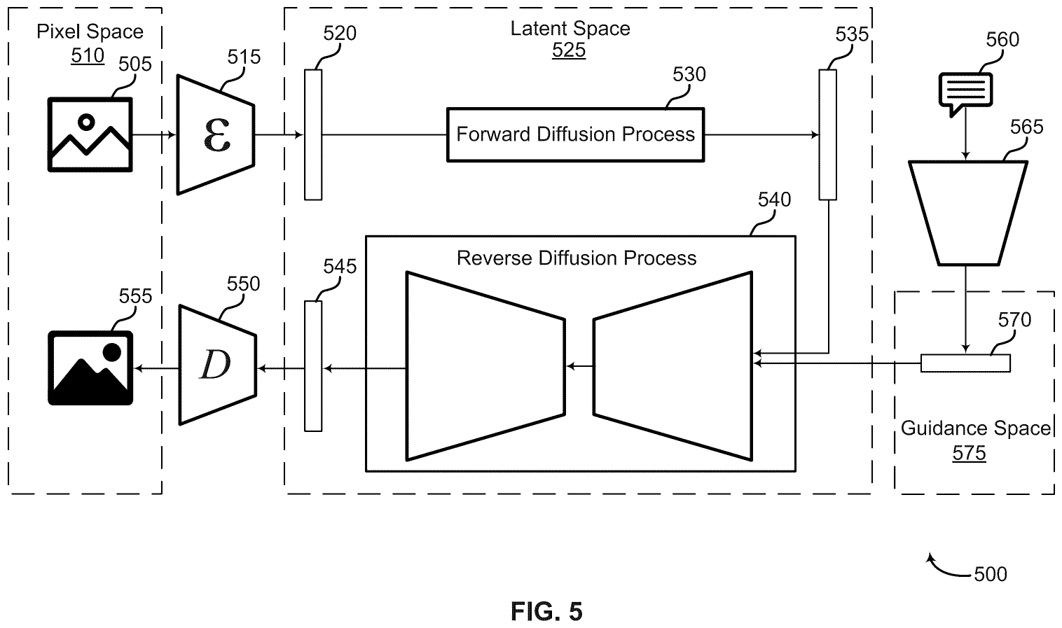

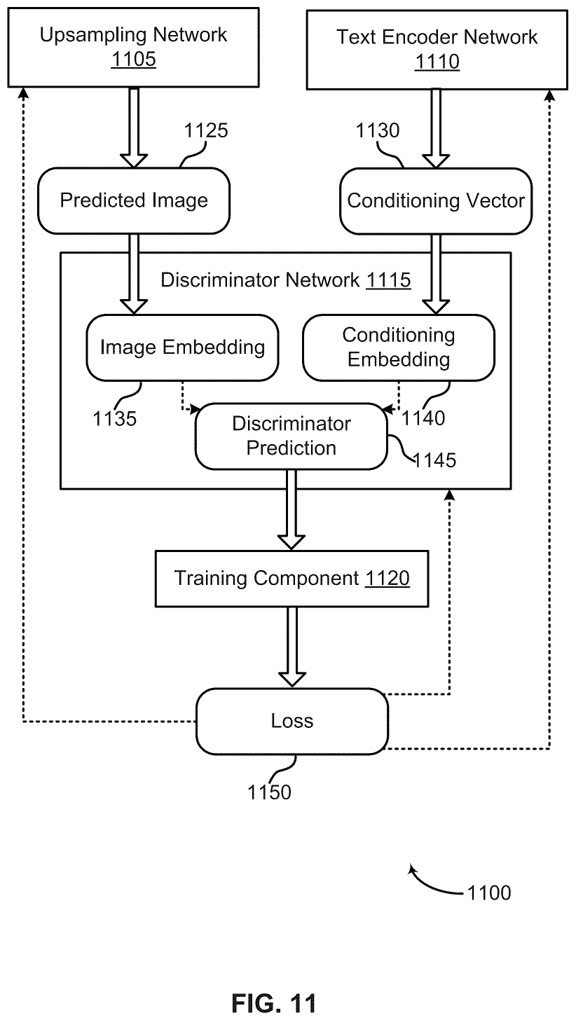

Image generation network 215 is configured to generate new image content. In some embodiments, image generation network 215 generates new content in the form of new objects or scene elements, while upsampling network 225 generates new content in the form of added detail to the objects or scene elements. Embodiments of image generation network 215 include a generative diffusion model, but the present disclosure is not necessarily limited thereto. Image generation network 215 is an example of, or includes aspects of, the corresponding element described with reference to FIGS. 3 and 11. An example of image generation network 215 as a generative diffusion model is described with reference to FIG. 5.

Compositing component 220 is configured to combine images or image content produced by image generation network 215 into another image. In an example, a user may supply an input image and a mask indicating a region of the input image, and image generation network 215 may then generate content within the constraints of the mask. Compositing component 220 combines the generated content with the input image to form a composite image. In at least one embodiment, the functions performed by compositing component 220 are performed by image generation network 215 instead.

According to some aspects, compositing component 220 combines the low-resolution image and the high-resolution image to obtain a composite image. In some examples, compositing component 220 inserts content of the low-resolution image into the region of the high-resolution image to obtain the composite image. Compositing component 220 is an example of, or includes aspects of, the corresponding element described with reference to FIG. 3.

Upsampling network 225 is configured to add detail to an image. Upsampling refers to the process of resampling in a multi-rate digital signal processing system. Upsampling can include expansion and filtering (i.e., interpolation). It may be performed on a sequence of samples of a signal (e.g., an image), and may produce an approximation of a sequence obtained by sampling the signal at a high rate or resolution. The process of expansion refers to the process of inserting additional data points (e.g., zeros or copies of existing data points). Interpolation refers to the process of smoothing out the discontinuities (e.g., with a lowpass filter). In some cases, the filter is called an interpolation filter.

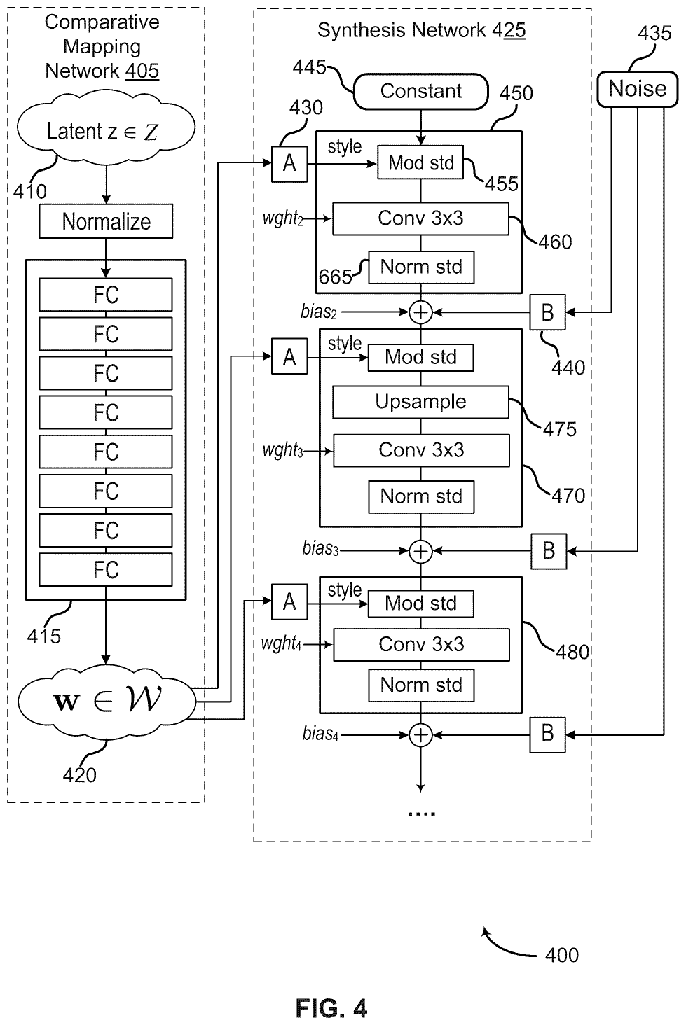

Embodiments of upsampling network 225 include a generative ANN such as a Generative Adversarial Network (GAN) that is configured to upscale an input image to produce an output image at a greater resolution than the input image. An example architecture of upsampling network 225 will be described with reference to FIG. 4.

According to some aspects, the system appends a downsampling layer to a pretrained upsampling network to obtain the upsampling network 225. In some examples, upsampling network 225 downsamples the high-resolution image to obtain the low-resolution image. In some examples, upsampling network 225 appends a Fast Fourier Convolution (FFC) layer to the pretrained upsampling network to obtain the upsampling network 225. In some aspects, the upsampling network 225 is trained as a generative adversarial network (GAN). For example, upsampling network 225 may be trained using a discriminator network that predicts images as real or synthetic. Upsampling network 225 is an example of, or includes aspects of, the corresponding element described with reference to FIGS. 3 and 11.

Training component 230 is configured to compute loss functions and to update parameters of image processing apparatus 200 based on the loss functions. For example, training component 230 may update parameters of one or more components of image processing apparatus 200 through a gradient descent process.

According to some aspects, training component 230 trains an upsampling network 225 to generate an upsampled composite image using training data including image-mask pairs. In some aspects, a mask indicating the region of a high-resolution training image is created using a mask generation model. In at least one embodiment, training component 230 is implemented on an apparatus different from image processing apparatus 200. Training component 230 is an example of, or includes aspects of, the corresponding element described with reference to FIG. 11.

Mask simulation component 235 is configured to generate synthetic masks used in the training of upsampling network 225. For example, mask simulation component 235 may segment a foreground object of a training image using a segmentation model, and then create a mask corresponding to a region of the foreground object. This mask may be paired with the image and used as a training sample. For example, the mask may be represented as a black and white or grayscale image of the same dimensions as the training image, and then combined with the RGB training image to form a 4-channel training sample. Mask simulation component 235 is an example of, or includes aspects of, the corresponding element described with reference to FIG. 10. In at least one embodiment, mask simulation component 235 is implemented on an apparatus different from image processing apparatus 200.

FIG. 3 shows an example of an upsampling pipeline according to aspects of the present disclosure. The example shown includes high resolution input image 300, text prompt 305, mask 310, image generation network 315, compositing component 320, text encoder 325, prompt embedding 340, noise vector 355, mapping network 360, style vector 365, composite input image 370, upsampling network 375, and output image with harmonized content 390.

Text prompt 305 is an example of, or includes aspects of, the corresponding element described with reference to FIG. 5. Mask 310 is an example of, or includes aspects of, the corresponding element described with reference to FIG. 11. Image generation network 315 is an example of, or includes aspects of, the corresponding element described with reference to FIGS. 2 and 11.

Compositing component 320 is an example of, or includes aspects of, the corresponding element described with reference to FIG. 2. Text encoder 325 is an example of, or includes aspects of, the corresponding element described with reference to FIGS. 2, 5, and 11. Mapping network 360 is an example of, or includes aspects of, the corresponding element described with reference to FIG. 4. Upsampling network 375 is an example of, or includes aspects of, the corresponding element described with reference to FIGS. 2 and 11.

The pipeline illustrated by FIG. 3 represents an end-to-end pipeline for inpainting generated content into an input image, and upsampling the results to produce an output composite image at the same or greater resolution than the input image. However, embodiments are not limited thereto, and in some examples, a pipeline may begin right before the upsampling process, e.g., after generated content is composited into an input image.

In an example, a user provides high resolution input image 300 and text prompt 305. In some cases, user additionally provides mask 310 at this stage. Image generation network 315 generates new image content while using the high resolution input image 300, the text prompt 305, and optionally the mask 310 as conditioning for the generation. The generated content is combined with high resolution input image 300 by compositing component 320 to form composite input image 370.

According to some aspects, text encoder 325 encodes text prompt 305 to generate prompt embedding 340. In some embodiments, text encoder 325 includes pretrained text encoder 330 and learned text encoder 335. Pretrained text encoder 330 may be based on a T5 encoder, but embodiments are not necessarily limited thereto. Learned text encoder 335 is configured to process an output from pretrained text encoder 330, and may be trained during a training phase. Examples of training processes are described with reference to FIGS. 10-12.

In some examples, prompt embedding 340 includes local vector(s) 345 and global vector 350. According to some aspects, local vector(s) 345 correspond to individual tokens of text prompt 305, and global vector 350 corresponds to text prompt 305 as a whole.

In an embodiment, global vector 350 and noise vector 355 are input to mapping network 360 to generate style vector 365. In some embodiments, mapping network 360 includes 4 multi-layer perceptron (MLP) layers, e.g., layers of an ANN model. Style vector 365 is denoted as vector w, and encodes information that is used to guide the synthesis of image content. In some aspects, style vector 365 is applied at different layers of upsampling network 375 to control synthesis at different levels of detail.

Upsampling network 375 receives prompt embedding 340, style vector 365, composite input image 370, and mask 310 as input. In some aspects, mask 310 is represented as a grayscale image of the same width and height dimensions as composite input image 370. In some examples, mask 310 is combined with composite input image 370 to form a 4-channel image that is input to upsampling network 375.

In one aspect, upsampling network 375 includes downsampling layers 380, convolutional layer 382, self-attention layer 384, cross-attention layer 386, and FFC layer 388. As a contrastive example, a different GAN-based upsampling network may have no downsampling layers, as this model is used only to upscale small images. Examples of present embodiments, however, include both downsampling and upsampling layers. In some aspects, the downsampling layers 380 enable upsampling network 375 to preserve high-resolution detail from the input image 300.

Upsampling network 375 includes aspects of a convolutional neural network (CNN), such as in convolutional layer 382. A CNN is a class of neural networks that is commonly used in computer vision or image classification systems. In some cases, a CNN may enable processing of digital images with minimal pre-processing. A CNN may be characterized by the use of convolutional (or cross-correlational) hidden layers. These layers apply a convolution operation to the input before signaling the result to the next layer. Each convolutional node may process data for a limited field of input (i.e., the receptive field). During a forward pass of the CNN, filters at each layer may be convolved across the input volume, computing the dot product between the filter and the input. During the training process, the filters may be modified so that they activate when they detect a particular feature within the input.

According to some aspects, upsampling network 375 increases performance of the image processing apparatus by integrating attention layers including self-attention layer 384 and cross-attention layer 386 with the convolutional backbone of StyleGAN. In some cases, the upsampling network 375 applies the Lipschitz L2-dist attention for both self-attention and cross-attention.

Fast Fourier Convolution (FFC) layer 388 is incorporated into a skip connection of upsampling network 375 to enable efficient transfer of detail from the high-resolution content contained in composite input image 370. FFC layers are efficient at capturing repeating patterns across large regions of an image. In some cases, composite input image 370 includes repeating details outside of the region of mask 310. FFC layers allow upsampling network 375 to efficiently transfer this detail into the region.

In this way, upsampling network 375 processes an image that includes low-resolution generated content and high-resolution content to produce an output image at high resolution with detailed inpainted content. In the example shown, image content of the dog within composite input image 370 is generated at a relatively low resolution that does not match with the surrounding image content of the room, dog bed, and flooring. The output image with harmonized content 390 from upsampling network 375 includes the dog at a higher resolution such that it matches with its surroundings.

Embodiments of an upsampling network according to the present disclosure include a style-based GAN. In some cases, the style-based GAN architecture enables the synthesis of additional detail for the image during the upsampling process. Generative adversarial networks (GANs) are a group of artificial neural networks where two neural networks are trained based on a contest with each other. Given a training set, the network learns to generate new data with similar properties as the training set. For example, a GAN trained on photographs can generate new images that look authentic to a human observer. GANs may be used in conjunction with supervised learning, semi-supervised learning, unsupervised learning, and reinforcement learning. In some embodiments, a GAN includes a generator network and a discriminator network. The generator network generates candidates while the discriminator network evaluates them. The generator network learns to map from a latent space to a data distribution of interest, while the discriminator network distinguishes candidates produced by the generator from the true data distribution. The generator network's training objective is to increase the error rate of the discriminator network, i.e., to produce novel candidates that the discriminator network classifies as real.

FIG. 4 shows an example of a style-based GAN according to aspects of the present disclosure. The example shown includes GAN upsampling network 400, mapping network 405, latent vector 410, fully connected layer 415, intermediate latent space 420, synthesis network 425, learned affine transform 430, noise input 435, learned per-layer scaling factors 440, constant input 445, first convolutional layer 450, modulation 455, convolution 460, normalization 465, second convolutional layer 470, upsampling 475, and third convolutional layer 480.

In this example, GAN upsampling network 400 is a StyleGAN2 model. StyleGAN or StyleGAN2 is an extension to the GAN architecture that uses an alternative generator network. StyleGAN includes using a mapping network 405 to map points in input latent space (e.g., latent vector 410 or vector z) to an intermediate latent space 420, using the intermediate latent space 420 to control style at each point, and introducing noise as a source of variation at each point in the generator network.

The mapping network 405 performs a reduced encoding of the original input and the synthesis network 425 generates, from the reduced encoding, a representation as close as possible to the original input. According to some embodiments, the mapping network 405 includes a deep learning neural network comprised of fully connected layers (e.g., fully connected layer 415). In some cases, the mapping network 405 takes a randomly sampled point from the input latent space, such as latent vector z, as input and generates a style vector w as output. Mapping network 405 is an example of, or includes aspects of, the corresponding element described with reference to FIG. 3.

According to some embodiments, the synthesis network 425 includes a first convolutional layer 450, a second convolutional layer 470, and a third convolutional layer 480. For example, the first convolutional layer 450 includes modulation 455, convolution 460 such as a conv 3×3, and normalization 465. A constant input 445, such as a 4×4×512 constant value, is input to the first convolutional layer 450. The output from first convolutional layer 450 is input to the second convolutional layer 470. The second convolutional layer 470 includes modulation, an upsampling layer (e.g., upsampling 475), convolution such as conv 3×3, and normalization.

According to an embodiment, the synthesis network 425 takes a constant input 445, for example, a 4×4×512 constant value, as input to start the image synthesis process. In some cases, the constant value is instead the composite input image as described with reference to FIG. 3. The style vector (e.g., vector w) generated from the mapping network 405 is transformed by learned affine transform 430 (i.e., denoted as block A) and is incorporated into each block of the synthesis network 425 before the convolutional layers (e.g., conv 3×3). In some cases, each block of the synthesis network 425 is referred to as a style block.

In some examples, with regards to original StyleGAN, the style vector (e.g., vector w) generated from the mapping network 405 is transformed by learned affine transform 430 (i.e., block A) and is incorporated into each block of the synthesis network 425 after the convolutional layers (e.g., conv 3×3) via the AdaIN operation, such as adaptive instance normalization. For example, an affine transform is a linear transformation that preserves parallel lines and ratios of distances in images. For example, an affine transform can be used to perform operations on an image, such as rotation, scaling, translation, and shearing. For example, by applying an affine transform to an image, the position, orientation, and scale of the image may be changed, whereas the overall shape and structure of the image are preserved. The original StyleGAN applies bias and noise within the style block, causing their relative impact to be inversely proportional to the current style's magnitudes. In some cases, the adaptive instance normalization layers can perform the adaptive instance normalization. The AdaIN layers perform a normalization process on the output of the feature map, which transforms the latent space to better align with the desired distribution of image features. For example, the output of the feature map is standardized to follow a Gaussian distribution, allowing a randomly selected feature map to represent a range of diverse features. The style vector is then added to this normalized feature map as a bias term, allowing the model to incorporate the desired style into the output image. This allows choosing a random latent variable so that the resulting output will not bunch up. In some cases, the output of each convolutional layer (e.g., conv 3×3) in the synthesis network 425 is a block of activation maps. In some cases, the upsampling layer doubles the dimensions of input (e.g., from 4×4 to 8×8) and is followed by another convolutional layer(s) (e.g., third convolutional layer).

Referring to FIG. 4, an example of StyleGAN2, more predictable results are obtained by moving these operations outside the style block, where they operate on normalized data. The synthesis network 425 enables normalization 465 and modulation 455 to operate on the standard deviation alone (i.e., the mean is not needed). The application of bias, noise, and normalization to the constant input 445 can also be removed.

According to an embodiment, block A denotes a learned affine transform 430 from W that produces a style, and block B is a noise broadcast operation. “Wght” or lower-case w is a learned weight. Lower-case b is a bias. The activation function (e.g., leaky ReLU) is applied right after adding the bias. The addition of bias b and B are outside active area of a style, and only the standard deviation is adjusted per feature map. In some cases, instance normalization is replaced with a “demodulation” operation, which is applied to the weights associated with each convolution layer.

In a style block (e.g., first convolutional layer 450), modulation 455 is followed by a convolution 460, and followed by normalization 465. The modulation 455 scales each input feature map of the convolution based on the incoming style, which can alternatively be implemented by scaling the convolution weights.

According to some embodiments, Gaussian noise is added to each of these activation maps. A different noise sample is generated for each block and is interpreted using learned per-layer scaling factors 440. In some embodiments, the Gaussian noise introduces style-level variation at a given level of detail.

FIG. 5 shows an example of a diffusion architecture 500 according to aspects of the present disclosure. FIG. 5 shows an example of an image generation network with a DDPM architecture according to aspects of the present disclosure. The guided latent diffusion model 500 depicted in FIG. 5 is an example of, or includes aspects of, the image generation network described with reference to FIG. 2.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 500 may take an original image 505 in a pixel space 510 as input and apply an image encoder 515 to convert original image 505 into original image features 520 in a latent space 525. Then, a forward diffusion process 530 gradually adds noise to the original image features 520 to obtain noisy features 535 (also in latent space 525) at various noise levels.

Next, a reverse diffusion process 540 (e.g., a U-Net ANN) gradually removes the noise from the noisy features 535 at the various noise levels to obtain denoised image features 545 in latent space 525. In some examples, the denoised image features 545 are compared to the original image features 520 at each of the various noise levels, and parameters of the reverse diffusion process 540 of the diffusion model are updated based on the comparison. Finally, an image decoder 550 decodes the denoised image features 545 to obtain an output image 555 in pixel space 510. In some cases, an output image 555 is created at each of the various noise levels. The output image 555 can be compared to the original image 505 to train the reverse diffusion process 540.

In some cases, image encoder 515 and image decoder 550 are pre-trained prior to training the reverse diffusion process 540. In some examples, they are trained jointly, or the image encoder 515 and image decoder 550 and fine-tuned jointly with the reverse diffusion process 540.

The reverse diffusion process 540 can also be guided based on a text prompt 560, or another guidance prompt, such as an image, a layout, a segmentation map, a mask as described with reference to FIG. 3, or the like. The text prompt 560 can be encoded using a text encoder 565 (e.g., a multimodal encoder) to obtain guidance features 570 in guidance space 575. The guidance features 570 can be combined with the noisy features 535 at one or more layers of the reverse diffusion process 540 to ensure that the output image 555 includes content described by the text prompt 560. For example, guidance features 570 can be combined with the noisy features 535 using a cross-attention block within the reverse diffusion process 540.

The following will now describe techniques and methods for upsampling low resolution content within a high resolution image.

### Image Generation and Upsampling

A method for image upsampling is described. One or more aspects of the method include obtaining a low-resolution image, a high-resolution image, and a mask indicating a region of the high-resolution image; combining the low-resolution image and the high-resolution image to obtain a composite image; and generating, using an upsampling network, an upsampled composite image based on the composite image and the mask.

Some examples of the method, apparatus, non-transitory computer readable medium, and system further include obtaining a text prompt. Some examples further include encoding the text prompt to obtain a text embedding, wherein the upsampled composite image is generated based on the text embedding.

Some examples of the method, apparatus, non-transitory computer readable medium, and system further include generating the low-resolution image based on the text prompt using an image generation network. In some cases, the image generation network includes a guided latent diffusion model such as the one described with reference to FIG. 4.

Some examples of the method, apparatus, non-transitory computer readable medium, and system further include downsampling the composite image to obtain a downsampled composite image. Some examples further include upsampling the downsampled composite image to obtain the upsampled composite image. In some aspects, the upsampled composite image has a same resolution as the high-resolution image.

Some examples further include inserting content of the low-resolution image into the region of the high-resolution image to obtain the composite image. Some examples of the method, apparatus, non-transitory computer readable medium, and system further include performing a Fast Fourier Convolution (FFC) in a skip connection of the upsampling network.

In some cases, an image generation network such as the example described with reference to FIGS. 2-3 and FIG. 5 is used to first generate the low-resolution image. According to some aspects, the low-resolution is generated using a diffusion process. FIG. 6 shows an example of a diffusion process 600 according to aspects of the present disclosure. As described above with reference to FIG. 5, a diffusion model can include both a forward diffusion process 605 for adding noise to an image (or features in a latent space) and a reverse diffusion process 610 for denoising the images (or features) to obtain a denoised image. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate images with successively greater noise, and a neural network is trained to perform the reverse diffusion process 610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy image 615 and denoises the data to obtain the p(xₜ₋₁|xₜ). At each step t−1, the reverse diffusion process 610 takes xt, such as first intermediate image 620, and t as input. Here, t represents a step in the sequence of transitions associated with different noise levels, The reverse diffusion process 610 outputs xₜ₋₁, such as second intermediate image 625 iteratively until x_{T} is reverted back to x₀, the original image 630. The reverse process can be represented as:

$${p}_{θ} ( {x}_{t - 1} \vert {x}_{c} ) := N ( {x}_{t - 1} ; {μ}_{θ} ( {x}_{t} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{L - 1} \vert {x}_{t} ) ,$$

where p(x_{T})=N(x_{T}; 0, I) is the pure noise distribution as the reverse process takes the outcome of the forward process, a sample of pure noise, as input and Πₜ₌₁^{T}p_{θ}(xₜ₋₁|xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

FIG. 7 shows an example of a method for harmonizing low-resolution image content within a high-resolution image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the system obtains a composite image including low-resolution image content and high-resolution image content, a mask corresponding to a region of the low-resolution image content, and a text description of the low-resolution image content. According to some aspects, the low-resolution image content is produced by an image generation network such as the model described with reference to FIG. 5, and according to the reverse diffusion process as described with reference to FIG. 6. In some cases, the high-resolution image content is provided in the form of a high-resolution input image from a user via a user interface. The text description of the low-resolution image content may correspond to a generation prompt that is also provided by the user via the user interface.

At operation 710, the system generates a style vector representing the text description. For example, style vector 365, as described with reference to FIG. 3, for the text description can be represented as w. In some cases, the operations of this step refer to, or may be performed by, a mapping network as described with reference to FIGS. 3-4.

At operation 715, the system generates an adaptive convolution filter based on the style vector. According to an embodiment, a sample-adaptive kernel selection process is performed once at each layer of the image generation network to generate an adaptive convolution filter. The sample-adaptive kernel selection process instantiates a large filter bank and selects weights from a separate pathway conditional on the w-space of StyleGAN to dynamically change convolution filters per sample.

According to an embodiment of the present disclosure, the image processing apparatus generates convolutional kernels based on text conditioning from, e.g., an embedding of a text prompt. The kernel selection method relates to instantiating a bank of N filters {Kᵢ∈ [symbol] ^{C}^{ᵢₙ}^{×C}^{ₒᵤₜ}^{×K×K}}ᵢ₌₁^{N}, (i.e., instead of one) that takes a feature f∈ [symbol] ^{C}^{ᵢₙ} at each layer. Next, the style vector w∈ [symbol] ^{d} goes through an affine layer [W_{filt}, b_{filt}]∈ [symbol] ^{(d+1)×N} that predicts a set of weights to average across the filters to generate an aggregated filter K∈ [symbol] ^{C}^{ᵢₙ}^{×C}^{ₒᵤₜ}^{×K×K}.

$$K = {\sum }_{i = 1}^{N} {K}_{i} \cdot softmax {( {W}_{filt}^{T} w + {b}_{filt} )}_{i} \qquad ( 3 )$$

The aggregated filter is used in the convolution pipeline of StyleGAN2 with the second affine layer [W_{mod}, b_{mod}]∈ [symbol] ^{(d+1)×C}^{ᵢₙ} for weight (de-)modulation.

$${g}_{adaconv} ( f , w ) = ( ( {W}_{m o d}^{T} w + {b}_{m o d} ) ⊗ K ) * f \qquad ( 4 )$$

where ⊗ and * represent (de-)modulation and convolution.

The softmax-based weighting is considered a differentiable filter selection process based on input conditioning at a high level. Furthermore, since the filter selection process is performed once at each layer, the selection process is significantly faster than the actual convolution which decouples compute complexity from the resolution. The kernel selection method is similar to dynamic convolutions such that the convolution filters dynamically change per sample. In some cases, the kernel selection method also differs from dynamic convolutions since the kernel selection method instantiates a large filter bank and selects weights from a separate pathway conditional on the w-space of StyleGAN.

At operation 720, the system downsamples the composite image using downsampling layers of an upsampling network. The system may downsample the composite image using downsampling layers of an upsampling network as described with reference to FIG. 3.

At operation 725, the system upsamples the composite image based on the adaptive convolution filter, the mask, and transferred detail from the high-resolution image content to generate a high-resolution image. According to some aspects, the system transfers detail from the high-resolution image content contained in the downsampling layers through skip connections. In some embodiments, the skip connections include FFC layers.

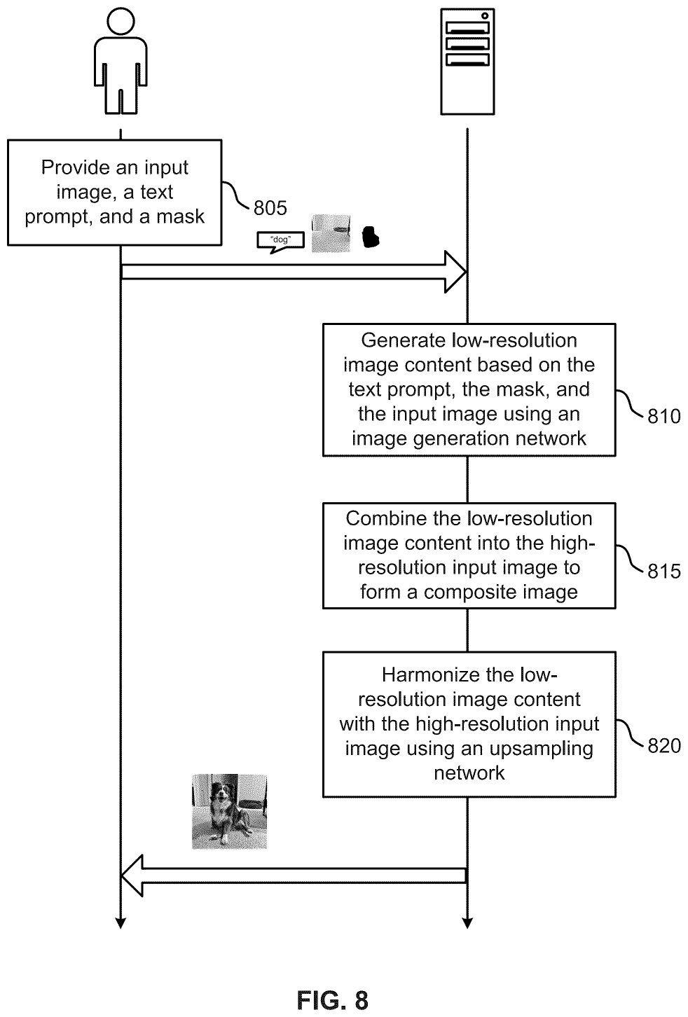

FIG. 8 shows an example of a method for inpainting or outpainting generated content onto an image according to aspects of the present disclosure. Inpainting, in the context of generative models, refers to generating new content within a region of an input image. Outpainting is similar, but instead refers to generating new content outside of the image and thereby extending the borders of the image. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, a user provides an input image, a text prompt, and a mask. The user may provide these inputs via a user interface, such as the one described with reference to FIG. 2. According to some aspects, the user defines a mask by painting or selecting a region of the image using a selection tool.

At operation 810, the system generates low-resolution image content based on the text prompt, the mask, and the input image using an image generation network. For example, the image generation network may generate the image according to a reverse diffusion process as described with reference to FIGS. 5-6.

At operation 815, the system combines the low-resolution image content into the high-resolution input image to form a composite image. The operations of this step may be performed by, for example, a compositing component as described with reference to FIG. 2. The composite image may include low-resolution content in the region of the mask, and high-resolution content elsewhere.

At operation 820, the system harmonizes the low-resolution image content with the high-resolution input image using an upsampling network. Operations of this step may be performed, for example, by an upsampling network described with reference to FIGS. 3-4. The upsampling process may include initially downsampling the composite image using downsampling layers, and then upsampling the downsampled composite image via upsampling layers that include convolutional, self-attention, and cross-attention layers. Some embodiments further include FFC layers between the downsampling layers and the upsampling layers to efficiently transfer high-resolution detail from the input image. In at least one embodiment, there are an equal number of downsampling layers and upsampling layers.

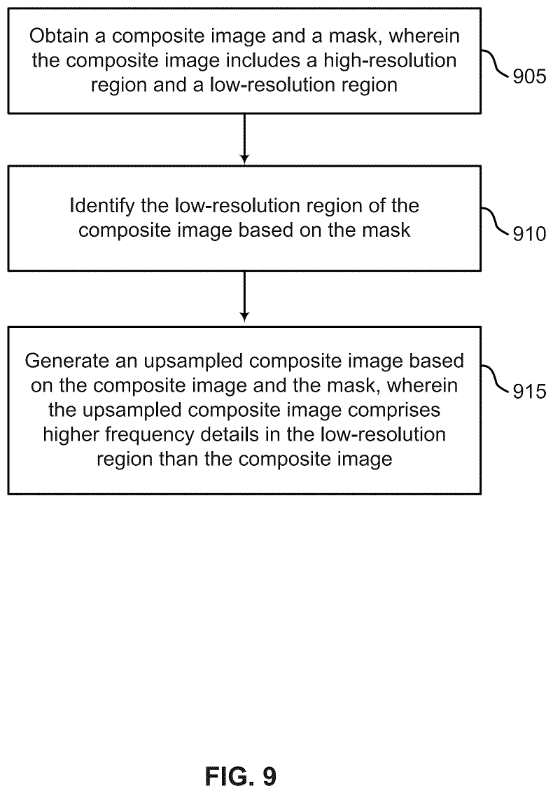

FIG. 9 shows an example of a method for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 905, the system obtains a composite image and a mask. The composite image includes a high-resolution region and a low-resolution region. The high-resolution region of the image may have higher frequency details than the low-resolution region. For example, the high-resolution region may be generated by an image that has a higher resolution than a source image for the low-resolution region. Accordingly, the low-resolution region may be an algorithmically upsampled version of a low-resolution image that does not have fine textures compared to the high-resolution region (i.e., the textures are based on a low-resolution image, so the region is more blurry or pixelated than the high-resolution region). Accordingly, the frequency of the detail may be determined by the original resolution of the content of each portion of the image.

In some cases, the operations of this step refer to, or may be performed by, an image processing apparatus as described with reference to FIGS. 1 and 2. In some cases, the system combines a low-resolution image and a high-resolution image to obtain a composite image. The high-resolution image and the mask may be provided from a user via a user interface, and in some cases, the low-resolution image may be provided from an image generation network.

At operation 910, an upsampling network identifies the low-resolution region of the composite image based on the mask. For example, the upsampling network can use the mask as guidance to generate content in the low-resolution region and retain content in the high-resolution region. In some examples, the upsampling network identifies the low-resolution region by multiplying the mask by image data or image features.

At operation 915, the upsampling network generates an upsampled composite image based on the composite image and the mask. The upsampled composite image comprises higher frequency details in the low-resolution region than the composite image. In some cases, the operations of this step refer to, or may be performed by, an upsampling network as described with reference to FIGS. 2, 3, and 11. Additional detail regarding the upsampling process is described with reference to FIGS. 3 and 7.

### Training

A method for image upsampling is described. One or more aspects of the method include obtaining training data including a composite image including a low-resolution region from a low-resolution image and a high-resolution region from a high-resolution image, a mask indicating the low-resolution region, and a ground-truth composite image and training an upsampling network to generate an upsampled composite image using the training data. According to some aspects, a training component such as the one described with reference to FIG. 2 updates parameters of the upsampling network based on a classification loss from a discriminator model using gradient descent. In some cases, the training component computes a different loss, such as a perceptual (e.g., feature-based) loss, or a pixel-loss such as L1.

Some examples of the method, apparatus, non-transitory computer readable medium, and system further include obtaining a pretrained upsampling network. Some examples further include appending a downsampling layer to the pretrained upsampling network to obtain the upsampling network. Some examples include downsampling the high-resolution image to obtain the low-resolution image. Some examples further include appending a Fast Fourier Convolution (FFC) layer to the pretrained upsampling network to obtain the upsampling network.

In some aspects, the upsampling network is trained as a generative adversarial network (GAN). In some aspects, the mask indicating the region of the high-resolution image is created using a mask generation model.

FIG. 10 shows an example of a pipeline for generating training images with masks according to aspects of the present disclosure. The example shown includes large dataset 1000, mask simulation component 1005, and training data 1010. Mask simulation component 1005 is an example of, or includes aspects of, the corresponding element described with reference to FIG. 2.

In one example, mask simulation component 1005 receives images from large dataset 1000. According to some aspects, mask simulation component 1005 processes the images to segment one or more foreground objects from the background. For example, mask simulation component 1005 may utilize a segmentation network that is configured to perform panoptic segmentation. Then, mask simulation component 1005 simulates a mask of the object by coloring the pixels corresponding to that object as, for example, black, and coloring the remaining pixels as white, and saving this mask image separately. Furthermore, mask simulation component 1005 may downsample the content within the region of the object to simulate a composite input image, similar to the one described with reference to FIG. 3.

According to some aspects, mask simulation component 1005 combines the simulated composite image with the mask to form a 4-channel image. Mask simulation component 1005 may repeat this process to yield training data 1010.

FIG. 11 shows an example training configuration for training a GAN-based upsampling network 1105 according to aspects of the present disclosure. The example shown includes training process 1100, upsampling network 1105, text encoder 1110, discriminator network 1115, training component 1120, predicted image 1125, conditioning vector 1130, image embedding 1135, conditioning embedding 1140, discriminator prediction 1145, and loss function 1150. Upsampling network 1105 is an example of, or includes aspects of, the corresponding element described with reference to FIGS. 2 and 3.

Text encoder 1110 is an example of, or includes aspects of, the corresponding element described with reference to FIGS. 2, 3, and 5. Training component 1120 is an example of, or includes aspects of, the corresponding element described with reference to FIG. 2. Mask 1155 is an example of, or includes aspects of, the corresponding element described with reference to FIG. 3.

Upsampling network 1105 generates predicted image 1125 by performing an upsampling process on a low-resolution input image. Text encoder network 1110 generates conditioning vector 1130 based on a text prompt.

According to an embodiment of the present disclosure, the discriminator network 1115 includes a StyleGAN discriminator. Self-attention layers are added to the StyleGAN discriminator without conditioning. In some cases, a modified version of the projection-based discriminator network 1115 incorporates conditioning.

According to an embodiment, discriminator network 1115 (also denoted as D(⋅,⋅)) includes two branches. A first branch is a convolutional branch ϕ(⋅) that receives an RGB image x and generates an image embedding 1135 of the RGB image x (image embedding is denoted as ϕ(x)). A second branch is a conditioning branch denoted as ψ(⋅). The conditioning branch receives conditioning vector 1130 (the conditioning vector is denoted as c) based on the text prompt. The conditioning branch generates conditioning embedding 1140 (conditioning embedding is also denoted as ψ(c)). Accordingly, discriminator prediction 1145 is the dot product of the two branches:

$$D ( x , c ) = {∅ ( x )}^{T} ψ ( c ) \qquad ( 5 )$$

Training component 1120 calculates loss function 1150 based on discriminator prediction 1145 during training process 1100. In some examples, loss function 1150 includes a non-saturating GAN loss. Training component 1120 is an example of, or includes aspects of, the corresponding element described with reference to FIG. 2. The machine learning model is trained using GAN loss as follows:

$${ℒ}_{G AN , real} = {E}_{x , c \sim {p}_{data}} [ log ( 1 + exp ( - {∅ ( x )}^{T} ψ ( c ) ) ] \qquad ( 6 )$$

$${ℒ}_{G A N , fake} = {E}_{x , c \sim {p}_{fake}} [ log ( 1 + exp ( {∅ ( x )}^{T} ψ ( c ) ) ] \qquad ( 7 )$$

In some embodiments, discriminator prediction 1145 measures the alignment of the image x with the conditioning c. In some cases, a decision can be made without considering the conditioning c by collapsing conditioning embedding 1140 (ψ(c)) to the same constant irrespective of c. Discriminator network 1115 utilizes conditioning by matching xᵢ with an unrelated condition c_{j≠i} taken from another sample in the minibatch {(xᵢ, cᵢ)}ᵢ^{N}, and presents the matching as fake images. The training component 1120 computes a mixing loss based on the image embedding and the mixed conditioning embedding, where the upsampling network 1105 is trained based on the mixing loss. The mixing loss is referred to as [symbol] _{mixaug} formulated as follows:

$${L}_{mixaug} = {E}_{\{ ( {x}_{i} , {c}_{i} ) \} \sim {p}_{data}} [ \frac{1}{N - 1} {\sum }_{j \neq i} log ( 1 + exp ( {ϕ ( {x}_{i} )}^{T} ψ ( {c}_{j} ) ) ) ] \qquad ( 8 )$$

According to some embodiments, equation (8) above relates to the repulsive force of contrastive learning which encourages the embeddings to be uniformly spread across the space.

$${E}_{{\{ ( {x}_{i} , {c}_{i} ) \}}_{i}} [ - log ( \frac{{e}^{{ϕ ( {x}_{i} )}^{T} ψ ( {c}_{i} )}}{{e}^{{ϕ ( {x}_{i} )}^{T} ψ ( {c}_{i} )} + {\sum }_{j \neq i} {e}^{{ϕ ( {x}_{i} )}^{T} ψ ( {c}_{j} )}} ) ] = {E}_{{\{ ( {x}_{i} , {c}_{i} ) \}}_{i}} log ( 1 + {\sum }_{j \neq i} exp ( \underbrace{{ϕ ( {x}_{i} )}^{T} ψ ( {c}_{j} )}_{repulsive} - \underbrace{{ϕ ( {x}_{i} )}^{T} ψ ( {c}_{i} )}_{attractive} ) ) \qquad ( 9 )$$

The two methods act to minimize similarity between unrelated image x and conditioning c, but the methods differ in that the logit of [symbol] _{mixaug} in Equation (8) is not pooled with other pairs inside the logarithm. In some cases, the formulation encourages stability and is not affected by hard negatives of the batch. Accordingly, discriminator network 1115 generates an embedding based on the convolutions and input conditioning to train the upsampling network 1105 that predicts a high-resolution image.

An embodiment of the present disclosure includes a class-conditional GAN trained on the ImageNet dataset. The machine learning model achieves generation quality comparable to generative models without a pretrained ImageNet classifier. In some cases, L2 self-attention, style-adaptive convolution kernel, and image-condition mixing are applied to the machine learning model and a wide synthesis network is used to train the base 64px model with a batch size of 1024. Additionally, a separate 256px class-conditional upsampler model is trained and combined with an end-to-end fine-tuning stage. Here, 64px means 64 pixels while 256px means 256 pixels.

In some cases, text-conditioning is added to StyleGAN2 and the configuration is tuned based on the findings of StyleGAN-XL. Next, the components, as described in the present disclosure, are added stepwise which consistently improve network performance. The model has high scalability, as the high-capacity version of the final formulation achieves improved metrics. The image processing apparatus achieves competitive performance when trained on a large model by increasing the capacity to 370M and batch size to 1248, which brings the parameter count similar to the smaller variant of Imagen.

In some cases, StyleGAN possesses a linear latent space for image manipulation, i.e., the W-space. An alternate embodiment of the disclosure performs coarse-grained and fine-grained style swapping using style vectors w. Embodiments of the present disclosure include an image processing apparatus that maintains a disentangled W-space which suggests that existing latent manipulation techniques of StyleGAN can transfer to the GAN upsampler model. Additionally, the GAN upsampler model possesses another latent space of text embedding t=[t_{local}, t_{global}] prior to W. In some cases, the t-space can also be utilized. According to an example, 3 different (z, t) pairs are mixed and matched and decoded into images. The results show a clear separation between the constraints dictated by the text embedding t, and the remaining attributes (i.e., the pose of the character in this case) controlled by the noise vector z.

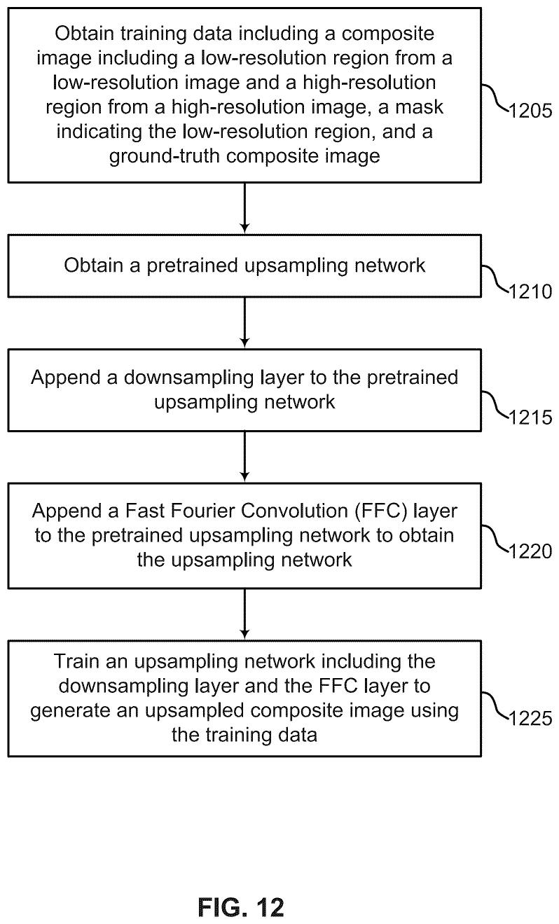

FIG. 12 shows an example of a method for image processing according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 1205, the system obtains training data including a composite image including a low-resolution region from a low-resolution image and a high-resolution region from a high-resolution image, a mask indicating the low-resolution region, and a ground-truth composite image. In some cases, the operations of this step refer to, or may be performed by, an image processing apparatus as described with reference to FIGS. 1 and 2. In some examples, the low-resolution region is simulated by downsampling content within a region of a training image, and the mask is simulated by identifying the region according to the process described with reference to FIG. 10. In some examples, the training data is provided in the form of a 4-channel image, where three channels correspond to red, green, and blue channels, and the fourth channel is the mask as a grayscale image.

At operation 1210, the system obtains a pretrained upsampling network. The pretrained upsampling network may be trained in a previous training phase according to the process described with reference to FIG. 11.

At operation 1215, the system appends a downsampling layer to the pretrained upsampling network. In some cases, the operations of this step refer to, or may be performed by, an image processing apparatus as described with reference to FIGS. 1 and 2. The downsampling layer may be appended at the front of the network, e.g., before the upsampling layers of the pretrained upsampling network. In some embodiments, a plurality of downsampling layers is appended to the front of the network. In some embodiments, the number of the downsampling layers equals the number of upsampling layers.

At operation 1220, the system appends a Fast Fourier Convolution (FFC) layer to the pretrained upsampling network to obtain the upsampling network. For example, the FFC layer may be applied within a skip connection that connects a downsampling layer to an upsampling layer. Additional detail regarding the FFC layer is described with reference to FIG. 4.

At operation 1225, the system trains an upsampling network including the downsampling layer and the FFC layer to generate an upsampled composite image using the training data. This operation may be performed by a training component as described with reference to FIG. 2. In some embodiments, the loss is computed according to Equations 6-8. In some embodiments, the training component computes a classification loss from a discriminator model using gradient descent. In some cases, the training component computes a different loss, such as a perceptual (e.g., feature-based) loss, or a pixel-loss such as L1. In this way, some embodiments are trained in a first phase, such as the process described with reference to FIG. 11 and fine-tuned in a second training phase after appending downsampling and FFC layers.

FIG. 13 shows an example of a computing device 1300 according to aspects of the present disclosure. The example shown includes computing device 1300, processor(s) 1305, memory subsystem 1310, communication interface 1315, I/O interface 1320, user interface component(s), and channel 1330.

In some embodiments, computing device 1300 is an example of, or includes aspects of, image processing apparatus 100 of FIG. 1. In some embodiments, computing device 1300 includes one or more processors 1305 are configured to execute instructions stored in memory subsystem 1310 to obtain a low-resolution image, a high-resolution image, and a mask indicating a region of the high-resolution image; combine the low-resolution image and the high-resolution image to obtain a composite image; and generate, using an upsampling network, an upsampled composite image based on the composite image and the mask.

According to some aspects, computing device 1300 includes one or more processors 1305. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1310 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1315 operates at a boundary between communicating entities (such as computing device 1300, one or more user devices, a cloud, and one or more databases) and channel 1330 and can record and process communications. In some cases, communication interface 1315 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1320 is controlled by an I/O controller to manage input and output signals for computing device 1300. In some cases, I/O interface 1320 manages peripherals not integrated into computing device 1300. In some cases, I/O interface 1320 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1320 or via hardware components controlled by the I/O controller.

According to some aspects, user interface component(s) 1325 enable a user to interact with computing device 1300. In some cases, user interface component(s) 1325 include an audio device, such as an external speaker system, an external display device such as a display screen, an input device (e.g., a remote-control device interfaced with a user interface directly or through the I/O controller), or a combination thereof. In some cases, user interface component(s) 1325 include a GUI.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also, the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a composite image and a mask, wherein the composite image includes a high-resolution region and a low-resolution region;
identifying, by an upsampling network, the low-resolution region of the composite image based on the mask; and
generating, using the upsampling network, an upsampled composite image based on the composite image and the mask, wherein the upsampled composite image comprises higher frequency details in the low-resolution region than the composite image.

2. The method of claim 1, further comprising:
obtaining a text prompt; and
encoding the text prompt to obtain a text embedding, wherein the upsampled composite image is generated based on the text embedding.

3. The method of claim 2, further comprising:
generating a low-resolution image based on the text prompt using an image generation network, wherein the composite image is based on the low-resolution image and the mask.

4. The method of claim 1, wherein generating the upsampled image comprises:
downsampling the composite image to obtain a downsampled composite image; and
upsampling the downsampled composite image to obtain the upsampled composite image.

5. The method of claim 1, wherein obtaining the composite image comprises:
obtaining a low-resolution image and a high-resolution image; and
combining the low-resolution image and the high-resolution image to obtain the composite image, wherein the high-resolution region is based on the high-resolution image and the low-resolution region is based on the low-resolution image.

6. The method of claim 1, further comprising:
performing a Fast Fourier Convolution (FFC) at a skip connection of the upsampling network.

7. The method of claim 5, wherein combining the low-resolution image and the high-resolution image comprises:
inserting content of the low-resolution image into the high-resolution image to obtain the composite image.

8. A method comprising:
obtaining training data comprising a composite image including a low-resolution region from a low-resolution image and a high-resolution region from a high-resolution image, a mask indicating the low-resolution region, and a ground-truth composite image; and
training an upsampling network to generate an upsampled composite image using the training data by upsampling the low-resolution region of the composite image based on the mask.

9. The method of claim 8, wherein training the upsampling network comprises:
obtaining a pretrained upsampling network; and
appending a downsampling layer to the pretrained upsampling network to initialize the upsampling network.

10. The method of claim 9, further comprising:
appending a Fast Fourier Convolution (FFC) layer to the pretrained upsampling network to obtain the upsampling network.

11. The method of claim 8, wherein:
the upsampling network is trained as a generative adversarial network (GAN).

12. The method of claim 8, wherein obtaining the training data comprises:
downsampling the high-resolution image to obtain the low-resolution image.

13. The method of claim 8, wherein:
the mask indicating the region of the high-resolution image is created using a mask generation model.

14. An apparatus comprising:
at least one processor;
at least one memory including instructions executable by the at least one processor; and
an upsampling network comprising parameters stored in the at least one memory, wherein the upsampling network is trained to generate an upsampled composite image based on a composite image and a mask, wherein the composite image includes a high-resolution region and a low-resolution region and the mask indicates the low-resolution region.

15. The apparatus of claim 14, wherein:
the upsampling network comprises a U-net architecture.

16. The apparatus of claim 14, wherein:
an upsampling layer of the upsampling network comprises an attention layer.

17. The apparatus of claim 14, wherein:
a skip connection of the upsampling network comprises Fast Fourier Convolution (FFC) layer.

18. The apparatus of claim 14, wherein:
the upsampling network comprises a generative adversarial network (GAN).

19. The apparatus of claim 14, further comprising:
an image generation network configured to generate the low-resolution image.

20. The apparatus of claim 14, further comprising:
a text encoder configured to encode a text prompt to generate a text embedding, wherein the upsampling network generates the upsampled composite image based on the text embedding.
